(19) United States
(12) Patent Application Publication
(10) Pub. No.: US 2007/0031542 A1
(43) Pub. Date: Feb. 8, 2007

(54) Encased food product and process for producing the same

(76) Inventors: Harry Chu, Chesterfield, MO (US); Matthew K. McMindes, Chesterfield, MO (US); Shaowen Wu, St. Louis, MO (US)

Correspondence Address: JAMES L. CORDEK;SOLAE, LLC, BUILDING 3C, LEGAL DEPARTMENT, P.O. BOX 88940, ST. LOUIS, MO, 63188, US

(21) Appl. No.: 11/199,891

(22) Filed: Aug. 9, 2005

(51) Int. Cl. A23L 1/36

(52) U.S. Cl. 426/93

(57) ABSTRACT

An encased food product and process for producing the same are disclosed. The encased food product includes a food material surrounded by an edible casing including a soy protein material. One embodiment for producing the encased food product includes coextruding a food material and a soy protein dough including a soy protein material and subsequently solidifying the soy protein coating surrounding the food material.

### FIELD OF THE INVENTION

The present invention generally relates to an encased food product and process for producing the same. More specifically, the present invention relates to a process for producing an encased food product including coextruding a food material and a soy protein dough.

### BACKGROUND OF THE INVENTION

Food products such as sausages, hot dogs, frankfurters, and the like, formed from either animal or vegetable food materials, often require casings to hold the food materials in a cylindrical or tubular shape during processing, pre-cooking, distribution, or final cooking by the consumer. Generally speaking, the casing materials used in the processing of these food products can be categorized as either edible or inedible.

Traditionally, the most common edible casing materials for such food products were natural casings made of animal viscera, such as sheep, hog, or beef intestines. These casing materials generally contribute to the overall appearance of the food product, typically do not have to be peeled off prior to consumption, and have many of the other physical and chemical properties that make a desirable container for ground or comminuted food products. However, a myriad of factors influence the quality of such natural casings including the health, specie, age, and conditions under which the animal was raised. Additionally, the intestinal tracts used as casing materials are highly microbiologically contaminated; therefore they must be cleaned and stripped of various internal and external layers in order to convert them into useful casings. As such, natural animal casings are typically reserved for the more expensive types of encased food products.

Today, edible casings are commonly formed from animal-derived collagen, such as from the corium layer of split beef hides. Food products encased in edible collagen casings are typically formed by either dry casing methods or wet coating methods known to those skilled in the art. In dry casing applications, the collagen casings are filled or stuffed with the food material, typically by attaching the casing to a nozzle or horn and ejecting or extruding the food materials into the casing. Wet coating applications, on the other hand, commonly involve what is known in the art as a coextrusion process. As opposed to filling empty casings with the food material, the coextrusion method forms a casing directly on the food material during processing. Typically, the casing is formed by coating a viscous gel or gel-like material containing collagen onto the food material and subsequently solidifying the coating to form the encased food product.

The use of collagen casing materials in either dry casing or coextrusion applications is typically preferred because the collagen is edible and it forms a good casing on the food product. For example, from a consumption standpoint, dry casing methods using collagen typically provide the best “snap” or “crunchy” bite, followed by casing materials containing collagen that have been formed by coextrusion methods. Inedible casing materials, such as cellulose, are typically peeled off prior to consumption and thus have no effect on eating quality. Additionally, food products encased in collagen materials often possess the flavor and appearance of natural casings, which is advantageous. Collagen materials, however, are relatively expensive and often require significant processing to form the encased food product. Moreover, many consumers desire food products that do not contain animal-derived materials due to religious, dietary, or personal reasons.

As such, a need in the industry exists for a process for producing an encased food product that uses a relatively inexpensive edible casing material that may be utilized in coextrusion applications. The casing should possess similar properties as that of conventional casing materials, such as good “snap” or “crunchy” bite, mouthfeel, strength, and water resistance. Additionally, a need exists for an encased food product and process for producing the same that possesses the above properties and that will appeal to broad ranges of consumers, such as vegetarians and non-vegetarians alike.

### SUMMARY OF THE INVENTION

The present invention is directed to a process for producing an encased food product. More specifically, the process utilizes coextrusion methods and the resulting casing includes a high level of soy protein material and is relatively inexpensive compared to conventional casing materials. Moreover, the encased food product includes a casing material that typically contains no animal-derived materials, thus widening its appeal into both the non-vegetarian and the vegetarian consumer markets.

Briefly, therefore, the present invention is directed to a process for producing an encased food product. The process comprises coextruding a food material and a soy protein dough to form a strand of food material and a coating comprising soy protein. The coating comprising soy protein is then solidified to form the encased food product. The soy protein dough comprises from about 10% (by weight) to about 25% (by weight) soy protein material.

The present invention is also directed to an encased food product comprising a food material and an outer casing. The outer casing surrounds the food material and comprises from about 15% (by weight) to about 70% (by weight) soy protein material.

The present invention is further directed to an encased food product comprising a food material and an outer casing. The outer casing surrounds the food material. The encased food product is formed by coextruding the food material and a soy protein dough. The soy protein dough comprises from about 10% (by weight) to about 25% (by weight) soy protein material.

Other objects and features will be in part apparent and in part pointed out hereinafter.

### BRIEF DESCRIPTION OF THE DRAWINGS

FIG. 1 illustrates one embodiment of the process of the present invention and additional processing steps.

### DETAILED DESCRIPTION OF THE INVENTION

The present invention is directed to an encased food product and a coextrusion process for making an encased food product. The encased food product includes an outer casing including soy protein material. It has been found that a high quality, low cost soy protein-containing casing can be formed on a food product using a coextrusion process including a food material and a soy protein dough to form an encased food product.

Suitable food materials for use in the processes of the present invention to produce an encased food product include food materials which are commonly encased by a casing material. Examples of such food materials include comminuted meat materials such as sausages, hot dogs, frankfurters, and the like. Alternatively, the food material may be a vegetable-derived material, such as a soybean-based product or similar product. Additionally, the food material may be a mixture of animal-based meat materials and/or non-meat materials such as soybean-based materials.

The coextrusion process utilized in the process of the present invention to produce an encased food product is a conventional process and includes pumping a food material through a center passageway of a coextruder. The coextruder also has additional passageways formed concentrically with respect to the center passageway for introducing additional components. The pumping of the food material through the center passageway creates a strand of food material of some defined shape. Though not narrowly critical, the strand of food material produced when making sausages, hot dogs, frankfurters, and the like is commonly a cylindrical or tubular shape. A casing material, in this case a soy protein-containing dough as described below, is pumped through the additional passageways described above onto the outer surface of the food material being extruded through the center passageway. The food material is thus coextruded with the soy protein dough, forming a strand of food material and a coating including soy protein. The temperature and feed rates of the components are not narrowly critical and a suitable temperature and feed rates can easily be determined by one skilled in the art. The types of coextrusion equipment and exact techniques that may be utilized in the processes of the present invention are not narrowly critical, as various techniques and coextrusion systems are known to those of skill in the art. Suitable equipment and methods of coextruding a food material and a casing material are described, for example, in U.S. Pat. No. 5,951,390 to Kobussen et al. and U.S. Pat. No. 6,419,968 to Wang et al., each of which is incorporated herein by reference. Examples of suitable commercially available coextrusion equipment for performing the coextrusion as described herein include the Kontura® system, the Co-Ex system, and the HiQ system, each available from Townsend Engineering Co., Des Moines, Iowa.

As noted above, a soy protein-containing dough is utilized in the coextrusion processes to produce an encased food product. The soy protein dough that is coextruded with the food material includes a soy protein material. The soy protein dough preferably includes from about 10% (by weight soy protein dough) to about 40% (by weight soy protein dough) soy protein material. More preferably, the soy protein dough includes from about 10% (by weight soy protein dough) to about 25% (by weight soy protein dough) soy protein material. Still more preferably, the soy protein dough includes from about 12% (by weight soy protein dough) to about 20% (by weight soy protein dough) soy protein material. Most preferably, the soy protein dough includes form about 15% (by weight soy protein dough) to about 18% (by weight soy protein dough) soy protein material. Suitable soy protein materials include soy flakes, soy flour, soy grits, soy meal, soy protein concentrates, soy protein isolates, and mixtures thereof The primary difference between these soy protein materials is the degree of refinement relative to whole soybeans. In a preferred embodiment, the soy protein material is a soy protein isolate.

Soy flakes are generally produced by dehulling, defatting, and grinding the soybean and typically contain less than about 65% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the comminuted materials and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 μm to about 1000 μm. Soy meal generally has a particle size of greater than about 1000 μm.

In one embodiment, the soy protein material in the soy protein dough is soy flour or soy protein concentrates. Soy protein concentrates typically contain about 65% (by weight dry basis) to less than 90% (by weight dry basis) soy protein, with the major non-protein component being fiber. Soy protein concentrates are typically formed from defatted soy flakes by washing the flakes with either an aqueous alcohol solution or an acidic aqueous solution to remove the soluble carbohydrates from the protein and fiber.

As noted above, in a preferred embodiment the soy protein material in the soy protein dough is soy protein isolates, which are highly refined soy protein materials. Specifically, soy protein isolates are processed to contain at least 90% (by weight dry basis) soy protein and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein (about pH 4.5) to precipitate the protein from the extract. The precipitated protein is separated from the extract, which retains the soluble carbohydrates, and is dried after being adjusted to a neutral pH or is dried without any pH adjustment. Numerous variations of the standard methods described above for producing a soy protein isolate are also known to those of skill in the art. For example, some processes utilize ultrafiltration membranes to separate the desired soy protein materials from the less desirable materials. Other processes may substitute water for the aqueous alkaline solution during the extraction step. The exact procedure used to produce the soy protein isolates utilized in the soy protein dough is not narrowly critical. Additionally, numerous commercially available soy protein isolates can be used to form the soy protein dough described herein. Suitable commercially available soy protein isolates for use in the present invention include SUPRO® Ex33 and SUPRO® 595, available from The Solae Company, St. Louis, Mo., and PRO-FAM® 646 and PRO-FAM® 974, available from ADM Specialty Food Ingredients, Netherlands.

In addition to the soy protein material, the soy protein dough may also include one or more other optional ingredients to enhance the functionality of the soy protein dough or provide other benefits. For example, the soy protein dough may include edible plasticizers, oils, phospholipids, protein materials other than those derived from soybeans, carbohydrates, anti-microbial agents, water, natural and artificial colorings and flavorings, and combinations thereof.

In one embodiment, the soy protein dough includes an edible plasticizer. The edible plasticizer increases the flexibility of the soy protein dough, making it sufficiently easily pumpable for use in standard coextrusion equipment. The edible plasticizer may also decrease the brittleness of the casing once it has been coextruded with, and solidified on, the food material. Suitable edible plasticizers include those commonly used in the food processing industry. Preferably, the edible plasticizer is a polyhydroxide such as a polyol. Suitable polyols for use as edible plasticizers in the soy protein dough include, for example, sorbitol, mannitol, maltitol, lactitol, fructose, glucose, glycerol, sucrose, high fructose corn syrups, propylene glycol, diethylene glycol, dipropylene glycol, and the like. Preferably, the edible plasticizer is glycerol. The soy protein dough may include from about 0% (by weight soy protein material) to about 100% (by weight soy protein material) edible plasticizer. Preferably, the soy protein dough includes from about 1% (by weight soy protein material) to about 100% (by weight soy protein material) edible plasticizer. More preferably, the soy protein dough includes from about 10% (by weight soy protein material) to about 50% (by weight soy protein material) edible plasticizer. Most preferably, the soy protein dough includes from about 15% (by weight soy protein material) to about 40% (by weight soy protein material) edible plasticizer.

The soy protein dough may also include one or more oils. The oil interacts with the hydrophobic regions of the soy proteins present in the soy protein material to increase the hydrophobicity of the soy protein dough once it has been coated and/or solidified on the food material. This allows the soy protein dough coating and/or the final encased food product to repel water, thus reducing the potential for dissolution during boiling or steam treatments. Additionally, the oil may act in a similar manner as the edible plasticizer, enhancing the flexibility of the soy protein dough to make it less viscous and more pumpable in standard coextrusion equipment.

Suitable oils that may be included in the soy protein dough include conventional food oils such as, for example, canola oil, coconut oil, corn oil, cottonseed oil, flaxseed oil, palm kernel oil, peanut oil, pumpkin seed oil, olive oil, safflower oil, sesame oil, soybean oil, and the like. One particularly preferred oil for use in the soy protein dough is soybean oil. An oil may be present in the soy protein dough at a concentration of from about 0% (by weight soy protein material) to about 65% (by weight soy protein material). Preferably, an oil is present in the soy protein dough at a concentration of from about 1% (by weight soy protein material) to about 65% (by weight soy protein material); more preferably from about 1% (by weight soy protein material) to about 30% (by weight soy protein material). Most preferably, an oil is present in the soy protein dough at a concentration of from about 2% (by weight soy protein material) to about 10% (by weight soy protein material).

The soy protein dough may also include one or more phospholipids, such as lecithin, which interact with the soy proteins present in the soy protein material. Lecithin is a mixture of fatty substances that are derived from the processing of soybeans. Lecithin can be separated from soybean oil by conventional means including through the addition of water and centrifugation or steam precipitation. Specifically, soy lecithin includes three types of phospholipids: phosplhatidylclholinie, phosphatidylethanolamine, and phosphatidylinositol.

The phospholipids act as emulsifying agents in the soy protein dough due to their polar and non-polar properties, which enable the mixing of other fats and oils with water in the soy protein dough. The presence of phospholipids also strengthens the oil-soy protein interactions to increase the overall strength of the soy protein casing. The phospholipids may also act in the same manner as the edible plasticizer, enhancing the flexibility of the soy protein dough to make it less viscous and more pumpable.

A phospholipid may be present in the soy protein dough at a concentration of from about 0% (by weight soy protein material) to about 20% (by weight soy protein material). Preferably, a phospholipid is present in the soy protein dough at a concentration of from about 1% (by weight soy protein material) to about 20% (by weight soy protein material); more preferably from about 1% (by weight soy protein material) to about 10% (by weight soy protein material). Most preferably, a phospholipid is present in the soy protein dough at a concentration of from about 1% (by weight soy protein material) to about 5% (by weight soy protein material).

Typically, the higher the concentration of the soy protein material in the soy protein dough, the more viscous (and less pumpable) the soy protein dough becomes. As such, the soy protein dough preferably includes at least one of the edible plasticizer, oil, and phosplholipids in order to maintain the pumpability of the soy protein dough through standard coextrusion equipment. For example, if the soy protein dough does not include either an oil or a phospholipid, then the edible plasticizer is preferably present in the soy protein dough at a concentration of at least about 20% (by weight soy protein material) to about 25% (by weight soy protein material). If the soy protein dough does not include either an edible plasticizer or a phospholipid, then an oil is preferably present in the soy protein dough at a concentration of at least about 60% (by weight soy protein material) to about 65% (by weight soy protein material). Finally, if the soy protein dough does not include either an edible plasticizer or an oil, then a phospholipid is preferably present in the soy protein dough at a concentration of from about 10% (by weight soy protein material) to about 25% (by weight soy protein material).

In addition to the above, the soy protein dough may also include protein materials other than those derived from soybeans. These additional protein materials can affect the functionality of the soy protein dough prior to coextrusion with the food material and/or once the soy protein dough has been coated and/or solidified on the food material. Specifically, some protein materials, such as gluten, assist in protein-protein bonding reactions between the soy proteins, thus enhancing the solidification of the soy protein dough into a suitable casing. Other protein materials, such as whey proteins or casein, may help lower the viscosity of the soy protein dough, allowing it to be sufficiently pumpable. Suitable protein materials (other than soy proteins) for use in the soy protein dough include edible proteins of animal and/or vegetable origin. Exemplary protein materials for use in the soy protein dough include, for example, gluten, casein, elastin, eggs, gelatin, collagen, and/or derivatives and combinations thereof. Protein materials (other than soy proteins) are preferably present in the soy protein dough at a concentration of less than about 50% (by weight soy protein material).

The soy protein dough may also include various carbohydrates. Carbohydrates can also affect the functionality of the soy protein dough once it has been coated and/or solidified on the food material. Specifically, carbohydrates provide a negative charge and hydrogen bonds which are used to create the protein networks that will help form the casing on the food material. Suitable carbohydrate materials for use in the soy protein dough include, for example, starch, polydextrin, maltodextrin, carboxymethylcellulose and salts thereof, and hydrocolloids such as alginate, carrageenan, pectin, xanthan gum, and the like. Carbohydrates are preferably present in the soy protein dough at a concentration of less than about 30% (by weight soy protein material).

The soy protein dough may also include one or more anti-microbial agents. Alternatively, anti-microbial agents may be present in the food material prior to being coextruded with the soy protein dough. Suitable anti-microbial agents for use in the soy protein dough include those commonly used as food additives in the food processing industry such as, for example, benzoic acid, butylparaben, butyl p-hydroxybenzoate, calcium benzoate, calcium propionate, calcium sorbate, chlorine, cupric sulfate, diethyl pyrocarbonate, ethyl p-hydroxybenzoate, heptylparaben, lactic acid, methylparaben, potassium acetate, potassium benzoate, potassium lactate, potassium metabisulfite, potassium propionante, potassium nitrate, potassium nitrite, potassium sorbate, propionic acid, propyl p-hydroxybenzoate, propylene oxide, propylparaben, sodium benzoate, sodium diacetate, sodium hydrogen sulfite, sodium lactate, sodium metabisulfite, sodium nitrate, sodium nitrite, sodium propionate, sodium sulfite, sodium thiocyanate, sorbic acid, sulfur dioxide, and the like. Particularly preferred anti-microbial agents are lactates and nitrates.

Preferably, anti-microbial agents are present in either the food materials or the soy protein dough at levels that are no higher than the legal limits allowed for that particular anti-microbial food additive, as directed by the Food and Drug Administration and the Department of Agriculture, Food Safety and Inspection Service, and as codified in various sections of the Code of Federal Regulations. For example, sodium lactates and potassium lactates are allowed for use as anti-microbial agents in various meat and poultry products at levels of up to 4.8% (weight/volume), while nitrites are allowed for use at levels of up to 200 ppm (see 9 C.F.R. §424.21).

As discussed above, the soy protein dough should be sufficiently easily pumpable to be utilized in standard coextrusion equipment known to those of ordinary skill in the art. In order to be sufficiently easily pumpable in standard coextrusion processes and equipment, the viscosity of the soy protein dough, as measured at 25° C. as a 10% (by weight) dispersion of soy protein dough in water, is preferably from about 3 centipoise to about 12 centipoise. More preferably, the viscosity of the soy protein dough, as measured at 25° C. as a 10% (by weight) dispersion of soy protein dough in water, is from about 5 centipoise to about 10 centipoise. Most preferably, the viscosity of the soy protein dough, as measured at 25° C. as a 10% (by weight) dispersion of soy protein dough in water, is from about 6 centipoise to about 8 centipoise. Within these ranges, the soy protein dough maintains its functionality and remains sufficiently easily pumpable in conventional coextrusion equipment.

One method of enhancing the pumpability of the soy protein dough is by adjusting the amounts of various components of the soy protein dough described above and/or the concentrations thereof. Another method of enhancing the pumpability of the soy protein dough is by optionally adjusting the pH of the soy protein dough. In order to be sufficiently easily pumpable in standard coextrusion processes and equipment, the pH of the soy protein dough, as measured at 25° C. as a 10% (by weight) dispersion of soy protein dough in water, is preferably from about 5.0 to about 10.0. More preferably, the pH of the soy protein dough, as measured at 25° C. as a 10% (by weight) dispersion of soy protein dough in water, is from about 6.0 to about 9.5. Most preferably, the pH of the soy protein dough, as measured at 25° C. as a 10% (by weight) dispersion of soy protein dough in water, is from about 6.5 to about 8.5.

The pH adjustment of the soy protein dough, if desired, is typically performed by adding a suitable alkaline composition to the soy protein dough mixture during the mixing process. The alkaline composition can be an alkaline solution or an alkaline powder. Preferably, the alkaline composition is an alkaline powder. Suitable alkaline compositions for use in the soy protein dough mixture include alkaline compositions commonly used in pH adjustment such as, for example, sodium carbonate, potassium carbonate, sodium hydroxide, calcium hydroxide, magnesium hydroxide, tetrasodium pyrophosphate, potassium hydroxide, and the like. One particularly preferred alkaline composition is sodium carbonate. The soy protein dough preferably includes from about 0% (by weight soy protein dough) to about 1% (by weight soy protein dough) of an alkaline composition. More preferably, the soy protein dough includes from about 0.1% (by weight soy protein dough) to about 0.8% (by weight soy protein dough) of an alkaline composition; most preferably from about 0.1% (by weight soy protein dough) to about 0.5% (by weight soy protein dough).

In one embodiment, the soy protein dough is formed by mixing an oil, a phospholipid, and a powdered alkaline composition with water at room temperature. An edible plasticizer may also be added in addition to, or in place of, the oil, phospholipids, or both. To this mixture a soy protein material is added and, optionally, other proteins and/or carbohydrates. The resulting mixture is stirred until it is uniformly mixed and substantially no lumps are present.

In another embodiment, the soy protein dough is formed by mixing soybean oil, lecithin, sodium carbonate powder, and glycerol in water, followed by the addition of the soy protein material and, optionally, other proteins and/or carbohydrates. The resulting mixture is stirred until it is uniformly mixed and substantially no lumps are present.

The soy protein dough may also be optionally de-aerated during and/or after the mixing process using a conventional de-aeration process. De-aeration may be achieved, for example, by placing a vacuum on the soy protein dough during and/or after the mixing process. The de-aeration process helps to remove air bubbles that can form in the soy protein dough during the mixing process. The substantial absence of air bubbles in the soy protein dough allows the soy protein dough to form a uniform coating on the food material when it is coextruded therewith. Typically, the soy protein dough is mixed using a vacuum shear pump. Suitable vacuum shear pumps are commercially available from IKA® Works, Inc., Wilmington, N.C.

In one embodiment, the soy protein dough includes from about 10% (by weight soy protein dough) to about 25% (by weight soy protein dough) soy protein material, from about 0% (by weight soy protein material) to about 100% (by weight soy protein material) edible plasticizer, from about 0% (by weight soy protein material) to about 20% (by weight soy protein material) phospholipid, from about 0% (by weight soy protein material) to about 65% (by weight soy protein material) oil, from about 0% (by weight soy protein dough) to about 1% (by weight soy protein dough) of an alkaline composition, and from about 50% (by weight soy protein dough) to about 90% (by weight soy protein dough) water. Preferably, the soy protein material is a soy protein isolate.

In another embodiment, the soy protein dough includes from about 12% (by weight soy protein dough) to about 20% (by weight soy protein dough) soy protein material, from about 10% (by weight soy protein material) to about 50% (by weight soy protein material) edible plasticizer, from about 1% (by weight soy protein material) to about 10% (by weight soy protein material) phospholipid, from about 1% (by weight soy protein material) to about 30% (by weight soy protein material) oil, from about 0.1% (by weight soy protein dough) to about 0.8% (by weight soy protein dough) of an alkaline composition, and from about 60% (by weight soy protein dough) to about 85% (by weight soy protein dough) water. Preferably, the soy protein material is a soy protein isolate.

In a particularly preferred embodiment, the soy protein dough includes from about 15% (by weight soy protein dough) to about 18% (by weight soy protein dough) soy protein isolate, from about 15% (by weight soy protein isolate) to about 40% (by weight soy protein isolate) glycerol, from about 1% (by weight soy protein isolate) to about 5% (by weight soy protein isolate) lecithin, from about 2% (by weight soy protein isolate) to about 10% (by weight soy protein isolate) soybean oil, from about 0.1% (by weight soy protein dough) to about 0.5% (by weight soy protein dough) sodium carbonate, and from about 70% (by weight soy protein dough) to about 85% (by weight soy protein dough) water.

Once the soy protein dough is coated on the food material by a suitable conventional coextrusion process, the coating should be solidified to form a substantially continuous outer casing around the strand of food material. The term “solidified” (or variants thereof) as used herein generally corresponds to the step involving the hardening and stabilization of the soy protein dough coating to form the casing around the strand of food material. As discussed in more detail below, the solidification of the soy protein dough is principally achieved by the dehydration of the soy protein dough and/or by protein-protein cross-linking reactions.

In one embodiment, the soy protein dough coating is solidified on the strand of food material by contacting the coating around the strand of food material with a solidifying solution to form an encased food product. It is contemplated that for purposes of the present invention the term “contacting” as used herein includes any manner of contacting the coated food material with the solidifying solution, such as by spraying, showering, painting, immersion in a bath, and the like, with combinations thereof being possible. For example, multiple immersion baths or multiple sprayers positioned in succession, or a combination of an immersion bath and a sprayer after the bath are contemplated. By way of further example, the strand of coated food material could rest on a moving conveyor belt and one or more nozzles positioned along the belt could spray the solidifying solution on the coated food material. Alternatively, the strand of coated food material could be carried on a conveyor belt and dropped into or carried through an immersion bath containing the solidifying solution. Additionally, in the preceding examples the strand of coated food material could be rotated on the conveyor belt in some manner to ensure uniform application of the solidifying solution.

In one embodiment, the solidifying solution includes a liquid smoke solidifying solution. Numerous liquid smoke formulations are known to those of skill in the art. Liquid smoke is typically formed by the pyrolysis of hardwoods followed by additional processing to formulate a composition that matches the flavor of traditional vaporous smoke. Liquid smoke formulations are commonly sold as a liquid or in powder form. Powdered liquid smoke formulations may be mixed with water to a suitable concentration, and liquid smoke formulations sold as a concentrated or unconcentrated liquids may also be mixed with water to a suitable concentration or used neat. Liquid smoke formulations typically comprise maltodextrin, caramel coloring, and other nutritional components such as preservatives and vitamins. Suitable commercially available liquid smoke formulations for use as a solidifying solution in the present invention include, for example, CharSol® M-15 and CharSol® Select 24, which are sold as a clear, brown liquid, and Maillose® Dry, which is sold as a yellow powder. These liquid smoke formulations are available from Red Arrow International LLC, Manitowoc, Wis.

The liquid smoke solution functions in a number of different ways to solidify the soy protein dough coating on the strand of food material to form a suitable encased food product. For example, the liquid smoke solution reduces the pH of the soy protein dough. This causes the soy proteins in the soy protein dough to undergo protein folding, and protein-protein interactions form an aggregated protein network that serves to solidify the coating. This solidification process forms the casing around the strand of food material.

Additionally, certain components in liquid smoke, such as aldehyde-containing components, can act as crosslinking agents in the soy protein matrix; that is, the liquid smoke and components therein form molecular links between adjacent proteins in the soy protein dough coating that result in a network of molecular links. Advantageously, the liquid smoke solution helps the soy protein material in the soy protein dough form a water-resistant film which prevents the development of a soggy, water-logged food material when the coated food product is reheated in water. Moreover, liquid smoke components such as sugars and maltodextrin can act as browning reagents to give the encased food product an appealing caramel color when the encased food product is cooked. Liquid smoke also imparts the flavor and smell of roasted, grilled or smoked foods.

Preferably, the liquid smoke solidifying solution includes from about 1% to about 50% of liquid smoke solids. More preferably, the liquid smoke solidifying solution includes from about 1% to about 30% of liquid smoke solids; most preferably from about 2% to about 10%. Typically, the pH of the liquid smoke solidifying solution is from about 2.0 to about 6.0. More preferably, the pH of the liquid smoke solidifying solution is from about 2.5 to about 5.0; most preferably, the pH is from about 3.5 to about 4.0. To solidify the soy protein dough coating, the strand of coated food material is preferably contacted with a liquid smoke solidifying solution having a temperature of from about 4° C. to about 60° C.; more preferably from about 10° C. to about 40° C.

Alternatively, other solidifying solutions may be used to solidify the soy protein dough coating on the strand of coated food material to form an encased food product. For example, in one embodiment the solidifying solution includes a divalent calcium cation-containing solution. A divalent calcium cation-containing solution can solidify the soy protein dough coating on the strand of food material by cross-linking the carboxyl groups on the soy proteins present in the soy protein dough coating to form a network of molecular links. Additionally, solidification may occur through the dehydration of the soy protein dough coating. Suitable divalent calcium cation-containing solutions include calcium lactate, calcium chloride, and calcium carbonate. One particularly preferred divalent calcium cation-containing solution is calcium lactate. Preferably, the calcium lactate solution is pH neutral, and preferably is at room temperature when it is contacted with the strand of coated food material. Alternatively, the calcium lactate solution may be at a temperature of from about 10° C. to about 55° C. when it is contacted with the strand of coated food material.

In yet another embodiment, the solidifying solution includes a sodium dihydrogen phosphate solution. Preferably, the sodium dihydrogen phosphate solution includes about 50% (weight/weight) aqueous sodium dihydrogen phosphate. The sodium dihydrogen phosphate solution generally causes the soy protein dough coating to solidify on the strand of coated food material by dehydration. The sodium dihydrogen phosphate solution also lowers the pH of the soy proteins in the soy protein dough coating, causing them to undergo protein folding, and the protein-protein interactions form an aggregated network that serves to solidify the coating. Preferably, the aqueous sodium dihydrogen phosphate solution has a pH of from about 3.0 to about 5.0. To solidify the soy protein dough coating, the strand of coated food material is preferably contacted with a sodium dihydrogen phosphate solution having a temperature of from about 4° C. to about 55° C.; more preferably from about 10° C. to about 35° C.

In another embodiment, the soy protein dough coating is solidified on the strand of coated food material by heating the coating around the strand of food material to form an encased food product. The heating process serves to aggregate the soy proteins and/or dehydrate the soy protein dough coating to form a suitable casing on the outer surface of the strand of food material. The heating process advantageously forms a continuous, uniform film casing around the strand of food material, characteristics which are particularly important in commercial scale food production applications such as the coextrusion of a food material and a coating material.

In a particularly preferred embodiment, the strand of coated food material is contacted with a solidifying solution as described above, followed by heating the strand of coated food material to further aggregate the soy proteins and/or dehydrate the soy protein dough to form an encased food product.

If heating is used to partially or completely solidify the soy protein dough coating, the strand of coated food material is typically heated at a temperature of greater than 100° C. Preferably, the strand of coated food material is heated at a temperature of from about 70° C. to about 180° C. More preferably, the strand of coated food material is heated at a temperature of from about 90° C. to about 145° C.; most preferably from about 110° C. to about 130° C. Suitable heating methods include hot air, microwave, and oven heating.

The strand of coated food material is preferably only heated for a period of time sufficient to solidify or further solidify the soy protein dough coating, but not long enough to partially or fully cook the coated food material. Typically, the strand of coated food material is heated for from about 20 seconds to about 60 seconds; more preferably for about 40 seconds.

Following the solidifying step(s) described above, the encased food product may be crimped to form links of desirable length. If, during the solidifying step, the strand of coated food material is heated for a period of time sufficient to cook or partially cook the coated food material, the crimping process may result in the undesirable opening of the casing at either or both ends of the crimped encased food product. As such, the strand of coated food material may be crimped prior to the heating step described above.

After solidifying the soy protein dough coating, and/or after crimping, the encased food product is optionally cooked to produce a ready-to-eat encased food product. Typically, the encased food product is cooked in a smokehouse. There are numerous cooking and smoking procedures and cycles thereof that are known to those of skill in the art, any of which may be used to produce the ready-to-eat encased food product according to the present invention. For example, the temperature and humidity of the smokehouse may be varied considerably. Generally speaking, however, the cooking process involves raising the internal temperature of the food material in the encased food product to at least about 70° C. to kill all harmful pathogens that may be present therein. Examples of suitable cooking methods include cooking the encased food product at a temperature of from about 35.5° C. to about 76.7° C. for about 20 minutes to about 45 minutes until the internal temperature of the encased food product reaches at least 70° C. Alternatively, the temperature can be gradually increased. For example, the encased food product can be cooked at a temperature of from about 35.5° C. for about 10 minutes, then at about 65.5° C. for about 15 minutes, and finally at about 76.7° C. for about 20 minutes until the internal temperature of the encased food product reaches at least 70° C.

In addition to cooking the encased food product in the smokehouse, the encased food product may be flavored by methods known to those of skill in the art. For example, smoke flavor may be added to the encased food product using particular smoke production methods and/or particular wood varieties. Additional applications of liquid smoke may also be applied in the smokehouse to flavor the encased food product.

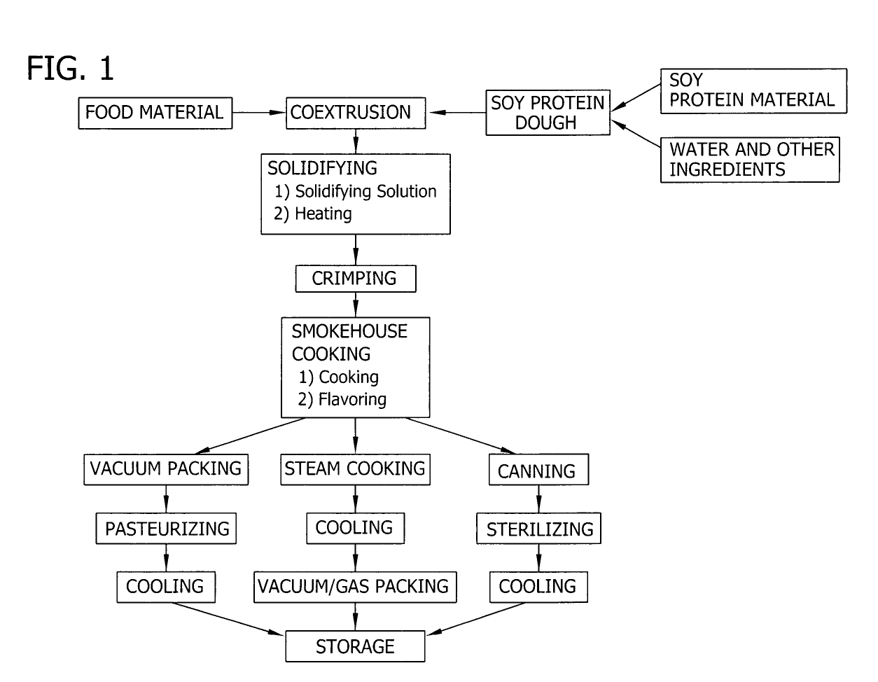

FIG. 1 illustrates one embodiment of the process of the present invention. As shown in FIG. 1, a food material and a soy protein dough including a soy protein material are coextruded. The soy protein dough coating on the strand of coated food material is then solidified by subjecting the coated food material to a solidifying step comprising contacting the coated food material with a solidifying solution, followed by heating the coated food material to produce an encased food product. Then, the encased food product is crimped to form links of a desired length. The encased food product is then cooked in a smokehouse, wherein additional flavoring is also added, to produce a ready-to-eat encased food product. Following cooking, the ready-to-eat encased food product undergoes various further sterilizing, pasteurizing, and packaging steps prior to final storage, as illustrated in FIG. 1. The various methods for preparing the encased food product for packaging and storage, such as sterilization, pasteurization, canning, and vacuum or gas packing, are known to those of skill in the art.

The process of the present invention thus yields an encased food product comprising a food material and an outer casing surrounding the food material comprising 15% (by weight) to about 70% (by weight) soy protein material. The outer casing preferably has a thickness of from about 18 micrometers to about 77 micrometers. More preferably, the outer casing has a thickness of from about 22 micrometers to about 64 micrometers; most preferably from about 25 micrometers to about 61 micrometers. One method of measuring the thickness of the outer casing is by peeling the casings from the food material following the cooking process and measuring the thickness of the casing with a caliper. Another method of measuring the thickness of the outer casing is by slicing the encased food product and placing the slice under a light microscope to determine the casing thickness. Suitable commercially available light microscopes for measuring the casing thickness are available from Nikon USA. In each of these and other methods, three readings may be taken at different locations of the casing and averaged to determine the thickness of the casing.

The outer casing surrounding the food material also has a tensile strength of from about 5 MPa to about 30 MPa. More preferably, the outer casing has a tensile strength of from about 8 MPa to about 20 MPa; most preferably from about 8 MPa to about 15 MPa. The tensile strength is the maximum tensile stress sustained by the casing during a tension test, tensile strength being equal to force per unit area. To measure the tensile strength of soy protein casings which may be formed on food materials by coextrusion according to the processes described herein, a sample casing may be formed (absent the food material and coextrusion process) for testing purposes. To form the sample casing, a strip of the soy protein dough is solidified according to the above processes (i.e., contacting the strip with a solidifying solution and heating the strip.) The tensile strength of the sample casing strip may be measured by preconditioning the sample casing strip of 24 hours in a controlled environment of about 21° C. and about 50% relative humidity and using a texture analyzer to determine the force required to break the sample casing strip. One particular method utilizes a TA.XT2 texture analyzer, available from Stable Micro Systems Ltd., England. According to this method, the ends of a 2.54 cm wide strip of the sample casing are covered with duct tape and the sample casing strip is placed in the tensile grips of the texture analyzer, the ends of which are 40 mm apart from each other. The force is measured as the strip is pulled at a rate of 0.8 mm/sec, and the force at the point the casing breaks may be utilized to determine tensile strength.

Similar methods may be utilized to measure the elongation strength (%) of the sample casing strip, which tends to vary considerably depending on the amounts of various components of the soy protein dough described above and/or the concentrations thereof. The elongation strength (%) can be measured by recording the distance that the sample casing strip is pulled before it breaks, dividing that distance by the distance the tensile grips are apart from each other (e.g., 40 mm), and multiplying by 100. Generally, it is preferred that the soy protein dough casings and/or the sample casing strips formed according to the processes described herein possess an elongation strength (%) that is similar or comparable to that of conventional collagen casings.

The encased food product produced by the process of the present invention also exhibits superior water soluble material loss percentages, as compared to collagen-encased food products. Preferably, the outer casing surrounding the strand of food material exhibits a water soluble material loss percentage after two hours of from about 10% to about 30%; more preferably from about 15% to about 25%. One method of measuring the water soluble material loss percentage is by measuring the weight of a sample casing strip formed as above before and after soaking the sample casing strip in water for about two hours. One specific method utilizes 2×2 cm strips of the sample casing which are preconditioned in a 50° C. oven for about 24 hours. The preconditioned strips are weighed and then immersed in 25° C. water for 2 hours. After soaking, the sample casing strips are gently dried to remove excess water, and the sample casings may be weighed to determine the water absorption based on the percentage of initial weight. Then, the sample casing is dried in a 50° C. oven for 24 hours and weighed to determine water soluble material loss.

Since the water soluble material loss percentage is relatively low for the encased food product, this corresponds to the encased food product having improved water resistance properties. Preferably, the encased food product of the present invention has a water resistance percentage after two hours of from about 70% to about 95%. More preferably, the water resistance percentage after two hours is from about 75% to about 90%; most preferably from about 75% to about 85%.

The soy protein casing that is applied to food materials according to the process described herein relies on the solidifying and cooking steps to form a substantially uniform, continuous film around the food material. Typical film-forming techniques and materials known in the art tend to produce films and encased products that have cracks or are subject to cracking. These cracks tend to weaken the overall strength of the casing or film, reduce the film or encased product's water resistance potential, and typically cannot be repaired. By contrast, the soy protein dough and the heating steps described herein for solidifying the soy protein dough result in an encased food product that is substantially free of cracks or the development thereof. Moreover, the solidifying solution (e.g., the liquid smoke solidifying solution) helps form a water resistant barrier which substantially prevents the development of sogginess upon cooking the encased food product in liquid for consumption.

Having described the invention in detail, it will be apparent that modifications and variations are possible without departing the scope of the invention defined in the appended claims. Furthermore, it should be appreciated that all examples in the present disclosure are provided as non-limiting examples.

### EXAMPLE 1

In this Example, a soy protein dough in accordance with the present invention is formed. 16.5 grams of glycerol (available from KIC Chemicals, Armonk, N.Y.), 5.5 grams of soybean oil (available from Bunge North America, St. Louis, Mo.), 2.75 grams of lecithin (CentroPhase 152, available from The Solae Company, St. Louis, Mo.), and 1.0 grams of sodium carbonate are introduced to 389.88 grams of water. This mixture is blended for approximately 5 minutes to dissolve the sodium carbonate powder. To this mixture, 82.5 grams of a soy protein isolate (SUPRO® 595, available from The Solae Company, St. Louis, Mo.) and 1.87 grams of alginate (available from TIC Gums, Inc., Belcamp, Md.) are added. The resulting mixture is blended under high shear for about 2 minutes at about 3400 RPM at room temperature until substantially no lumps are present to form a soy protein dough including 16.5% (by weight) soy protein isolate. The pH of the soy protein dough is about 7-8, and the soy protein dough has a viscosity of about 7 centipoise.

### EXAMPLE 2

In this Example, the soy protein dough formed according to the method of Example 1 is coextruded with a food material to produce an encased food product. Also, two collagen-encased food products are formed for comparison to the soy protein encased product.

First, a coextruder is formed by inserting one hand-operated extruder (i.e., the meat extruder) into a second hand-operated extruder (i.e., the casing material extruder). The gap between the meat extruder and the casing material extruder allows the passage of the casing material. As the meat and the casing material are separately extruded from their respective extruders, the casing material is deposited on the outer surface of the meat, as by coextrusion.

The soy protein-coated food product is produced using the above coextruder. The food material is a sausage, and the coextruder coats the sausage with a 200-300 μm layer of the soy protein dough formed according to the process described in Example 1. Following coextrusion, the coated food material is sprayed for about 30 seconds with a 5% liquid smoke solidifying solution (pH 3.0-3.8) (CharSol® M-15, available from Red Arrow International LLC, Manitowoc, Wis.) to solidify the coating. The soy protein dough casing is further solidified by heating the coated food material in a 125° C. forced-air oven for about 15 to 20 minutes.

The two collagen-encased food products are also produced using the above coextruder. The collagen dough is a 4% collagen protein (available from Devro, Inc., Columbia, S.C). The food material is a sausage, and the coextruder coats the sausage with a 890-1520 μm layer of the collagen dough. Following coextrusion, the collagen coating on the food material is solidified by immersing the collagen-coated food material in a 50% K₂HPO₄ solution for about 40 seconds. One collagen-encased food product control (#1) is then dried at room temperature for about 14 to 18 hours. The other collagen-encased food product control (#2) is heated in an 82° C. forced-air oven for about 15 to 20 minutes.

The casings applied to the food products are analyzed by forming sample casings for testing purposes without the food material and the coextrusion process. A strip of the soy protein dough of Example 1 and a strip of the collagen dough are solidified into sample casings using the processes performed with respect to the coextrusion process above (i.e., contacting the strips with a solidifying solution and heating the strips). This process provides a slightly thicker casing upon solidification than normal (˜100-110 μm) which is more practical for testing purposes than the thinner casings on the encased food products formed by coextrusion.

The final film thickness (μm), tensile strength (MPa), elongation strength (%), water absorption (%) after two hours, and water soluble material loss (WSML) (%) after two hours are analyzed for the soy protein casing forned from the soy protein dough of Example 1 and the two collagen casing controls, and the results are illustrated in Table 1 below.

TABLE 1

| | Film | Elongation | Tensile | WSML | Water |
|---|---|---|---|---|---|
| | Thickness | Strength | Strength | (%), | Absorption |
| Sample | (μm) | (%) | (MPa) | 2 hr | (%), 2 hr |
| Soy Protein | 101.6 | 4.1 | 15.2 | 17.9 | 212.0 |
| Casing | | | | | |
| Collagen | 106.7 | 5.8 | 12.9 | 53.6 | 192.5 |
| Casing #1 | | | | | |
| Collagen | 101.6 | 2.9 | 8.0 | 55.6 | 183.6 |
| Casing #2 | | | | | |

As illustrated in Table 1, the soy protein casing exhibited improved tensile strength as compared to the collagen casing controls. Additionally, the soy protein casing has improved water resisting properties as compared to the collagen casing controls. One reason for the improved water resistance is the significantly lower water soluble material loss percentage exhibited by the soy protein casing.

What is claimed is:

1. A process for producing an encased food product, the process comprising:
coextruding a food material and a soy protein dough to form a strand of food material and a coating, the coating comprising soy protein; and
solidifying the coating comprising soy protein to form the encased food product;
wherein the soy protein dough comprises from about 10% (by weight soy protein dough) to about 25% (by weight soy protein dough) soy protein material.

2. The process as set forth in claim 1 wherein the soy protein material is selected from the group consisting of soy flakes, soy flour, soy grits, soy meal, soy protein concentrate, soy protein isolate, and combinations thereof.

3. The process as set forth in claim 1 wherein the soy protein dough further comprises from about 1% (by weight soy protein material) to about 100% (by weight soy protein material) edible plasticizer.

4. The process as set forth in claim 1 wherein the soy protein dough further comprises from about 1% (by weight soy protein material) to about 65% (by weight soy protein material) oil.

5. The process as set forth in claim 1 wherein the soy protein dough further comprises from about 1% (by weight soy protein material) to about 20% (by weight soy protein material) phospholipids.

6. The process as set forth in claim 1 wherein the soy protein dough further comprises an alkaline composition.

7. The process as set forth in claim 6 wherein the alkaline composition is sodium carbonate.

8. The process as set forth in claim 1 wherein the soy protein dough further comprises an additional component selected from the group consisting of non-soy based proteins, carbohydrates, anti-microbial agents, and combinations thereof.

9. The process as set forth in claim 1 wherein the soy protein dough has a pH of from about 5 (10% solution at 25° C.) to about 10 (10% solution at 25° C.).

10. The process as set forth in claim 1 wherein the soy protein dough has a viscosity of from about 3 centipoise (10% solution at 25° C.) to about 12 centipoise (10% solution at 25° C.).

11. The process as set forth in claim 1 wherein the soy protein dough comprises from about 10% (by weight soy protein dough) to about 25% (by weight soy protein dough) soy protein material, from about 0% (by weight soy protein material) to about 100% (by weight soy protein material) edible plasticizer. from about 0% (by weight soy protein material) to about 20% (by weight soy protein material) phospholipids, from about 0% (by weight soy protein material) to about 65% (by weight soy protein material) oil, from about 0% (by weight soy protein dough) to about 1% (by weight soy protein dough) of an alkaline composition, and from about 50% (by weight soy protein dough) to about 90% (by weight soy protein dough) water.

12. The process as set forth in claim 11 wherein the soy protein material is a soy protein isolate.

13. The process as set forth in claim 1 wherein the soy protein dough comprises from about 15% (by weight soy protein dough) to about 18% (by weight soy protein dough) soy protein isolate, from about 15% (by weight soy protein isolate) to about 40% (by weight soy protein isolate) glycerol, from about 1% (by weight soy protein isolate) to about 5% (by weight soy protein isolate) lecithin, from about 2% (by weight soy protein isolate) to about 10% (by weight soy protein isolate) soybean oil, from about 0.1% (by weight soy protein dough) to about 0.5% (by weight soy protein dough) sodium carbonate, and from about 70% (by weight soy protein dough) to about 85% (by weight soy protein dough) water.

14. The process as set forth in claim 1 wherein the coating is solidified using at least one method selected from the group consisting of contacting the coating and the strand of food material with a solidifying solution, heating the coating and the strand of food material, and combinations thereof.

15. The process as set forth in claim 14 wherein the solidifying solution is selected from the group consisting of a liquid smoke solidifying solution, a divalent calcium-containing solution, sodium dihydrogen phosphate, and combinations thereof.

16. The process as set forth in claim 14 wherein the heating is done at a temperature of from about 70° C. to about 180° C.

17. The process as set forth in claim 1 further comprising crimping the strand of food material prior to solidifying the coating.

18. The process as set forth in claim 1 further comprising crimping the encased food product after solidifying the coating.

19. The process as set forth in claim 1 further comprising cooking the encased food product in a smokehouse after solidifying the coating.

20. An encased food product comprising:
a food material, and
an outer casing surrounding the food material, wherein the outer casing comprises from about 15% (by weight) to about 70% (by weight) soy protein material.

21. The encased food product as set forth in claim 20 wherein the soy protein material is a soy protein isolate.

22. The encased food product as set forth in claim 20 wherein the outer casing has a thickness of from about 18 micrometers to about 77 micrometers.

23. The encased food product as set forth in claim 20 wherein the outer casing has a tensile strength of from about 5 MPa to about 30 MPa.

24. The encased food product as set forth in claim 20 wherein the outer casing has a water soluble material loss percentage after two hours of from about 10% to about 30%.

25. An encased food product comprising:
a food material, and
an outer casing surrounding the food material, wherein the encased food product is formed by coextruding the food material and a soy protein dough, the soy protein dough comprising from about 10% (by weight) to about 25% (by weight) soy protein material.

26. The encased food product as set forth in claim 25 wherein the soy protein material is a soy protein isolate.

27. The encased food product as set forth in claim 25 wherein the outer casing has a thickness of from about 18 micrometers to about 77 micrometers.

28. The encased food product as set forth in claim 25 wherein the outer casing has a tensile strength of from about 5 MPa to about 30 MPa.

29. The encased food product as set forth in claim 25 wherein the outer casing has a water soluble material loss percentage after two hours of from about 10% to about 30%.
